(19) United States
(12) Patent Application Publication
(10) Pub. No.: US 2010/0059232 A1
(43) Pub. Date: Mar. 11, 2010

(54) SYSTEM AND METHOD FOR RETAINING AN ELEMENT

(75) Inventors: Michael D. Langlais, Houston, TX (US); Tage Thorkildsen, Raege (NO)

Correspondence Address: SCHLUMBERGER RESERVOIR COMPLETIONS, 14910 AIRLINE ROAD, ROSHARON, TX, 77583, US

(73) Assignee: Schlumberger Technology Corporation, Sugar Land, TX (US)

(21) Appl. No.: 12/495,100

(22) Filed: Jun. 30, 2009

Related U.S. Application Data
(60) Provisional application No. 61/094,453, filed on Sep. 5, 2008.

(51) Int. Cl. E21B 19/16; F16L 25/00; E21B 17/00; E21B 23/00

(52) U.S. Cl. 166/380; 403/11; 166/242.1

(57) ABSTRACT

The instant patent application discloses, among other things, a sand management system comprising an upper sand management portion and a lower sand management portion and an extendable leak-off tube. When the leak-off tube is in a fully retracted position, the leak-off tube is securely releasably engaged with upper sand management portion and when the leak-off tube is in a fully extended position, it is securely releasably engaged with the lower sand management portion.

Also disclosed herein is a method for dehydrating a slurry in an area between an upper sand management portion and a lower sand management portion. The method includes installing a leak-off tube between the upper sand management portion and the lower sand management portion and securely releasably connecting the leak-off tube to the lower sand management portion.

### RELATED APPLICATIONS

This application claims priority to provisional patent application Ser. No. 61/094,453 filed on 5 Sep. 2008, incorporated herein by reference.

### BACKGROUND

Sand control devices are typically utilized within a well to manage the production of solid material, such as sand. Screens are commonly used sand control devices in well completions in which the producing formation is poorly or loosely consolidated. Abrasive particulates, generally referred to as “sand” or “fines”, can cause problems if produced. For example, the formation surrounding the wellbore can erode and wash out, potentially leading to collapse of the well. Sand can damage equipment such as pumps or seals as the sand travels at high speed through the pump or past the seals. Produced sand must be disposed of, and this imposes an additional cost to the well operator. Fines can clog flow passages, disrupting production.

Often, to enhance filtration, a layer of particles of presorted size, commonly referred to as “gravel”, is injected between the formation (or casing) and the screen. In those cases, the screen is sized to prevent passage of the gravel. The gravel in turn prevents the passage of fines.

To place the gravel within the correct position (e.g., in the annulus between the sand screen and the casing or borehole wall) the gravel is pumped downhole in a carrier fluid as a slurry. As the gravel reaches the desired position, the slurry “dehydrates,” i.e., the carrier fluid leaves the slurry depositing the settled gravel within the annulus. As the slurry dehydrates, the carrier fluid can return uphole through the sand screen or enter the formation.

In some instances, two sand screens will be separated by a length of tubing such as blank pipe. However, during gravel packing, the annulus between that separator tubing and the casing of borehole will receive gravel slurry, but the carrier fluid will not have a path to return uphole, i.e., because the blank pipe does not have an opening allowing the carrier fluid to flow through, the slurry may be trapped.

In order to allow the carrier fluid to flow back uphole, a leak-off tube may be positioned within the annulus surrounding the blank pipe connecting the two screens. The leak off tube may contains openings which allow the gravel slurry to dehydrate within the annulus. As is seen in FIG. 1, the leak-off tube 10 remains retracted within the screen shroud 70 until the two screens are joined prior to running in hole. To prevent the leak-off tube 10 from prematurely sliding out of the retention ring 30, a set screw 100 is engaged with the leak-off tube 10 to hold the leak-off tube 10 in place. At the desired time, e.g., when two joints of screen are joined, the set screw 100 is loosened and the leak-off tube is extended to attach to the lower screen joint (shown in FIG. 2B).

However, the set screw 100 is not an ideal retention mechanism because (1) it is difficult to determine if it is engaged by visual inspection and (2) if, for example, the screen is jarred the set screw may come loose causing the leak-off tube to prematurely extend. This premature extension may cause lost time on the rig as well as be a safety hazard if the leak-off tube slips out of its retaining ring 30 while the screen joint is above the rig floor.

Therefore, there is a desire for a mechanism for more securely retaining the leak-off tube 10 within its retaining ring 30.

### BRIEF DESCRIPTION OF THE DRAWINGS

FIG. 1 shows a leak-off tube retained by a set screw.

FIGS. 2A and 2B show a spring latch mechanism to retain the leak-off tube.

FIGS. 3A and 3B show another view of a spring latch mechanism to retain the leak-off tube.

FIG. 4 shows the operation of a spring latch mechanism to retain the leak-off tube.

FIGS. 5 and 5A show an alternative retention mechanism to retain the leak-off tube.

FIGS. 6A and 6B show another alternative retention mechanism to retain the leak-off tube.

FIGS. 7A and 7B show a safety mechanism to prevent the leak-off tube from disengaging completely from the upper sand management portion.

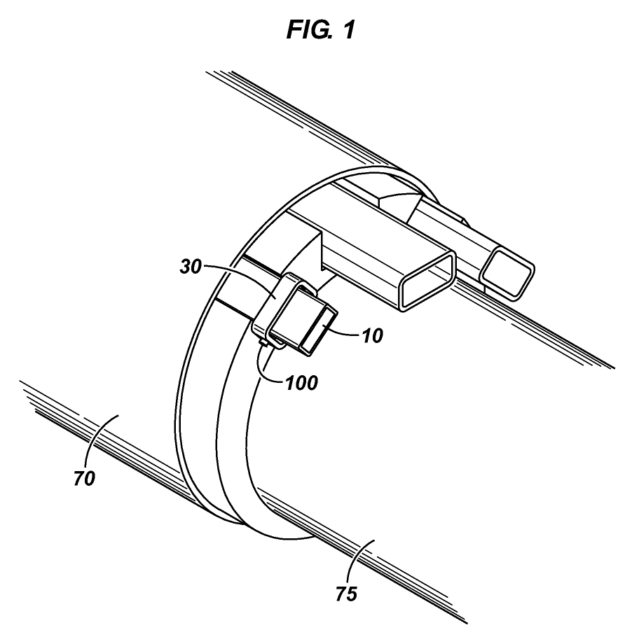

### SUMMARY

One embodiment disclosed herein is a completion comprising a sand management system comprising an upper sand management portion and a lower sand management portion and an extendable leak-off tube; wherein when the leak-off tube is in a fully retracted position, the leak-off tube is securely releasably engaged with upper sand management portion and when the leak-off tube is in a fully extended position, it is securely releasably engaged with the lower sand management portion.

In another embodiment disclosed herein, there is disclosed a method for dehydrating a slurry in an area between an upper sand management portion and a lower sand management portion. The method comprises installing a leak-off tube between the upper sand management portion and the lower sand management portion and securely releasably connecting the leak-off tube to the lower sand management portion.

### DETAILED DESCRIPTION

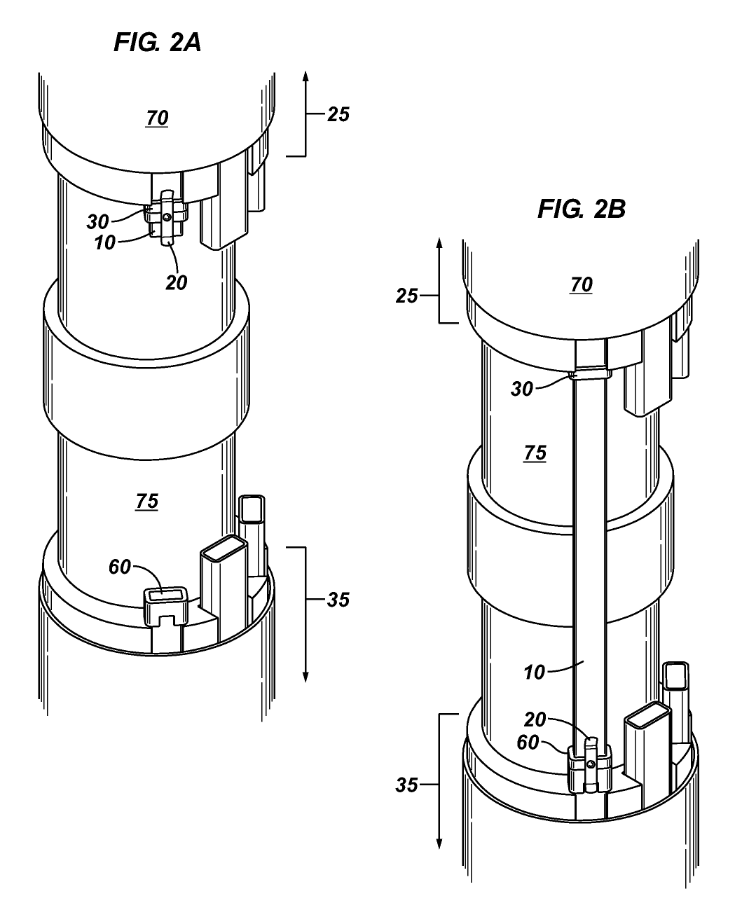

Referring now to FIGS. 2A and 2B, there is shown a piece of blank pipe 75 connecting an upper sand management assembly 25 and a lower sand management assembly 35. Beneath shroud 70 may be a sand screen (not shown). In FIG. 2A, leak off tube 10 is securely releasably attached to retaining ring 30 by spring latch 20. When desired, spring latch 20 is disengaged (e.g., manually) from retaining ring 30 extended into the position shown in FIG. 2B and securely releasably attached to lower retaining ring 60. When extended and engaged with lower sand management assembly 35, leak-off tube 10 will allow dehydration of gravel slurry as it is deposited within the annulus between blank pipe 75 and the casing or borehole (not shown).

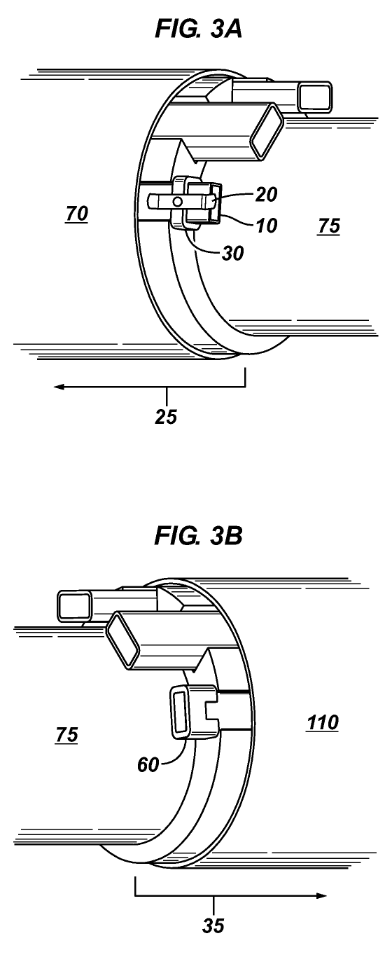

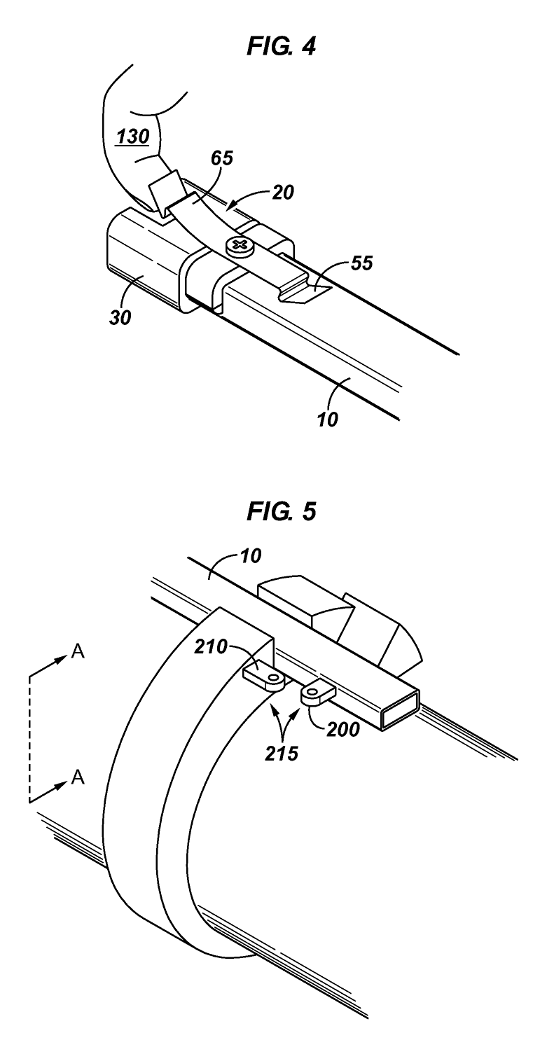

Shown in FIGS. 3A and 3B is a close-up alternate view of the upper and lower retention mechanisms as shown in FIGS. 2A and 2B. As explained above with respect to FIGS. 2A and 2B, in its retracted position, leak-off tube is securely releasably attached to retaining ring 30. To manually disengage the leak-off tube, as is shown in FIG. 4, the engaged upper portion 65 of the spring latch 20 is lifted manually by finger 130 or any other suitable means. The leak-off tube 10 is then slid downward and extended between upper sand management assembly 25 and lower sand management assembly 35. When extended, the lower portion 55 of spring latch 10 is then securely attached to lower retaining ring 60.

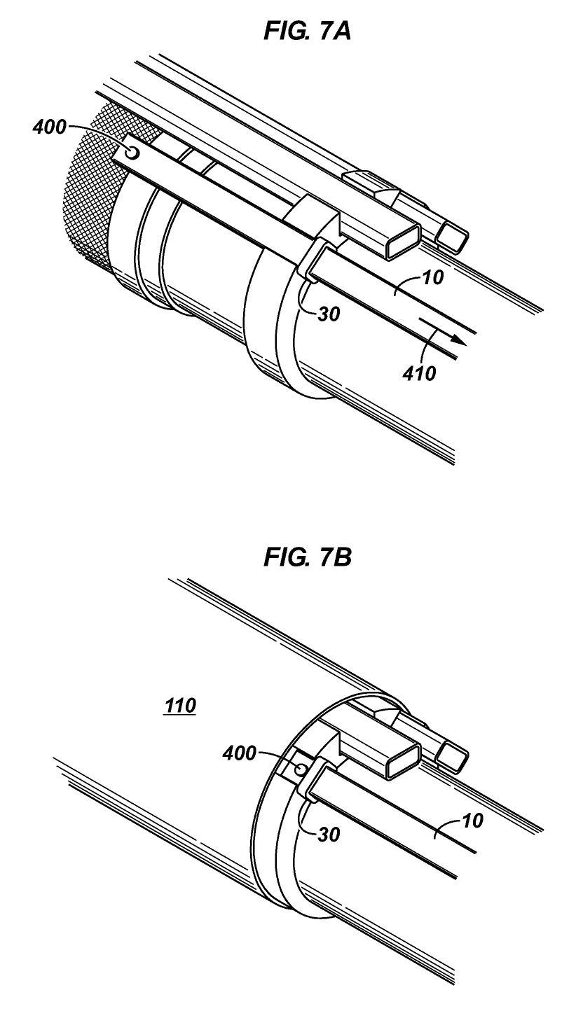

Referring now to FIG. 7A and 7B, there is shown in FIG. 7A and 7B a leak-off tube 10 which slides within retaining ring 30 as described above. As leak-off tube 10 slides towards the lower retaining ring (not shown) in direction 410, at the end of leak-off tube 10, is safety screw 400 to act as a safety mechanism to prevent leak-off tube 10 from inadvertently and/or prematurely sliding out of retaining ring 30. In FIG. 7A, shroud 110 (shown in FIG. 7B). Safety screw 400 is shown in this embodiment to be a screw, however, it is not necessary to be a screw and can be any device which prevents leak-off tube 10 from inadvertently and/or prematurely sliding out of retaining ring 30.

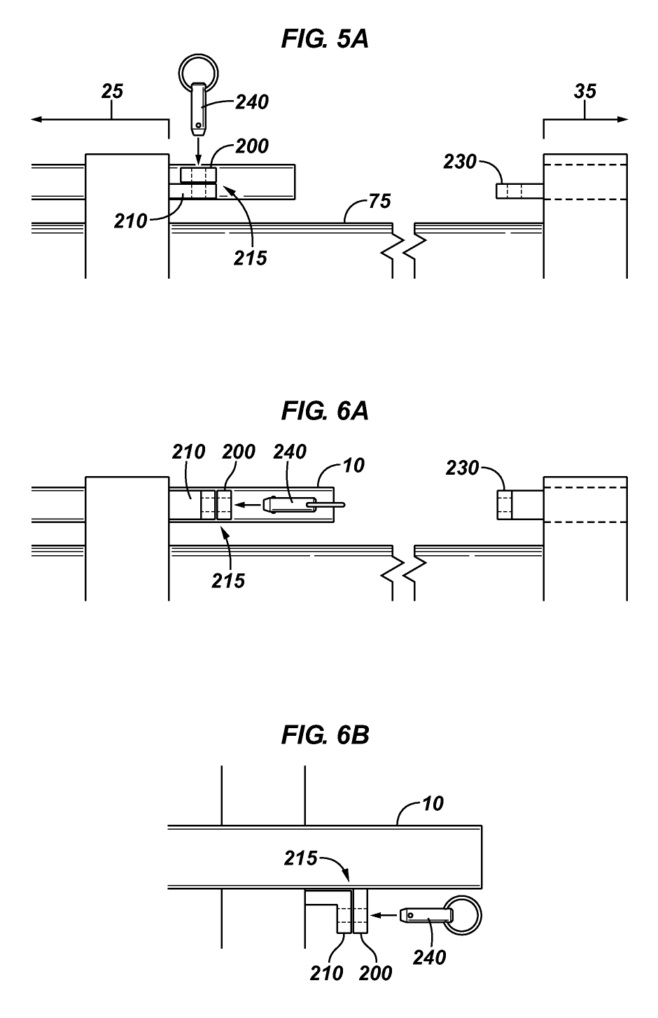

Referring now to FIGS. 5 and 5A, there is shown an alternative embodiment of a leak-off tube 10 having a releasable secure retention mechanism. In the embodiment shown in FIGS. 5 and 5A, the leak-off tube 10 comprises a retaining element 200 which, when the leak-off tube is retracted, aligns with retaining element 210, attached to the upper sand control assembly. While in alignment, a pin 240 is inserted through both elements 200 and 210 of the upper retention mechanism 215. When it is desirable to extend the leak-off tube 10, the pin 240 is removed from the upper retention mechanism 215. The leak-off tube 10 is then extended to the lower sand management assembly 35 wherein the retaining element 200 is aligned with retaining element 230 and pin 240 inserted to prevent undesirable movement or sliding of the leak-off tube 10.

In the alternative embodiment of FIGS. 6A and 6B, rather than be arranged so as to slide together longitudinally (as in FIGS. 5 and 5A) such that the pin 240 is inserted radially to secure the leak-off tube 10, the retention mechanisms are arranged such that the pin 240 is inserted in a radial direction. It should be understood that the precise directional arrangement of the mating pieces is not critical to the operation of the retention mechanism and other arrangements are possible so long as the alignment of the separate retention mechanisms allow the insertion of the retention pin.

Although only a few example embodiments of the present invention are described in detail above, those skilled in the art will readily appreciate that many modifications are possible in the example embodiments without materially departing from the novel teachings and advantages of this invention. Accordingly, all such modifications are intended to be included within the scope of this invention as defined in the following claims. For example, the shape of the pin is not limited to that pictured in the figures. It is the express intention of the applicant not to invoke 35 U.S.C. §112, paragraph 6 for any limitations of any of the claims herein, except for those in which the claim expressly uses the words ‘means for’ together with an associated function.

1. A system for releasably securing a leak-off tube within a sand management system comprising:
a means for latching; and
a means for releasably securely retaining the means for latching.

2. The system of claim 1 wherein the latch retaining means is securely releasably engaged when the leak-off tube is fully retracted.

3. The system of claim 1.1 wherein the latch retaining mechanism is securely releasably engaged when the leak-off tube is fully extended.

4. The system of claim 1 wherein the means for latching is a spring latch.

5. The system of claim 1 wherein the means for latching comprises a retaining pin.

6. The system of claim 1 further comprising a safety device for preventing the leak-off tube from disengaging from the sand management system.

7. A completion comprising:
a sand management system comprising an upper sand management portion and a lower sand management portion;
an extendable leak-off tube;
wherein when the leak-off tube is in a fully retracted position, the leak-off tube is securely releasably engaged with upper sand management portion and when the leak-off tube is in a fully extended position, it is securely releasably engaged with the lower sand management portion.

8. The completion of claim 7 wherein the extendable leak-off tube is securely releasably engaged by a spring latch.

9. The completion of claim 7 wherein the extendable leak-off tube is securely releasably engaged by a mechanism comprising a pin.

10. The completion of claim 7 further comprising a safety device for preventing the leak-off tube from disengaging from the upper sand management portion.

11. A method for dehydrating a slurry in an area between an upper sand management portion and a lower sand management portion, the method comprising:
installing a leak-off tube between the upper sand management portion and the lower sand management portion; and
securely releasably connecting the leak-off tube to the lower sand management portion.

12. The system of claim 11 wherein the securely releasably connecting the leak-off tube comprises securely releasably connecting the leak-off tube with a spring latch.

14. The system of claim 11 wherein the securely releasably connecting the leak-off tube comprises securely releasably connecting the leak-off tube with a mechanism comprising a retaining pin.

15. The system of claim 11 further comprising a safety device to prevent the leak-off tube from disengaging from the upper sand management portion.
